(19) United States
(12) Patent Application Publication
(10) Pub. No.: US 2013/0305238 A1
(43) Pub. Date: Nov. 14, 2013

(54) METHOD FOR UPDATING A SOFTWARE APPLICATION HOSTED BY AN EQUIPMENT ITEM ON BOARD AN AIRCRAFT

(71) Applicant: AIRBUS OPERATIONS (S.A.S.), Toulouse (FR)

(72) Inventors: ANNE FRAYSSIGNES, Saint-Andre (FR); FRÉDÉRIC SAUGNAC, Sanguinet (FR)

(73) Assignee: AIRBUS OPERATIONS (S.A.S.), Toulouse (FR)

(21) Appl. No.: 13/890,522

(22) Filed: May 9, 2013

(30) Foreign Application Priority Data
May 11, 2012 (FR) 12 54323

(51) Int. Cl. G06F 9/445

(52) U.S. Cl. CPC G06F 8/65
USPC 717/173

(57) ABSTRACT

A method for updating a software application stored in an equipment item on board an aircraft. The method comprises downloading update files to an on-board dataloader, checking the integrity and authenticity of the new software application version, transmitting this new software application version to the equipment item concerned, storing the new software application version in question into a standby memory zone of said equipment item, while this equipment item is still controlled by a previous version of said software application stored in an active memory zone, distinct from said standby memory zone, and finally, switching said standby and active memory zones, said equipment item being then controlled by the new software application version stored in the active memory zone after the memory zones have been switched.

### CROSS-REFERENCE TO RELATED APPLICATION

This application claims priority to French Patent Application No. 12 54323 filed May 11, 2012, the entire disclosure of which is herein incorporated by reference.

### TECHNICAL FIELD

The present invention relates generally to the field of maintenance of software applications on board an aircraft.

### BACKGROUND

Present-day aircraft have much on-board equipment items, which are generally controlled by software applications stored in their internal memory. These equipment items consist of modular systems, also called LRUs (Line Replaceable Units) which can be replaced or, more often, have their software applications updated by the maintenance teams. Examples of such equipment items include computers in the avionics bay such as the FMC (Flight Management Computer), or actuator control devices located outside this bay.

Operations to update the abovementioned software applications are often complex, and account for a large proportion of the time which aircraft spend immobilised. The equipment item(s) concerned by the update must, indeed, be identified beforehand, the new software applications must be prepared on the ground, conveyed on board using computer storage means, and then read by an on-board device reader. The maintenance personnel must then select the equipment items concerned by the update, ensure that the update is successfully loaded, and then ensure that the new configurations of the equipment items are satisfactorily in conformity with the maintenance instructions. In aircraft of recent design it is also necessary, on board the aircraft, to check the authenticity and integrity of the software applications before they are downloaded into the various equipment items.

These operations are repeated frequently, and generally relate to all the aircraft of a given type within a fleet. It is therefore essential to make them as simple and as rapid as possible.

To this end, it has been proposed to “pre-import” the new software applications automatically immediately after the aircraft lands. More specifically, the software applications to be downloaded into the equipment items are transmitted in “push” mode, in the form of IP packets, via a wireless link, into the storage zone of an on-board loading device (also called a dataloader). More specifically, the maintenance server automatically detects that the aircraft is present, and transmits directly the software application(s) in question to the loading device. This automatic downloading may appreciably shorten the update operations, since a substantial proportion of the file transfers is accomplished even before the maintenance personnel goes aboard the aircraft.

The aim of the present invention is to enable the operations to update the software applications on board an aircraft to be shortened and automated.

### SUMMARY

The present invention is defined as a method for updating a software application stored in an equipment item on board an aircraft, including:
downloading of files to update said software application, from a maintenance server on the ground to an on-board dataloader, where said update files include a new version of the software application;
a first check of the integrity and authenticity of the new version of the software application by said on-board dataloader, where said method is characterised in that it also includes:
transmission of the new version of the software application by the on-board dataloader to the on-board equipment item, when said check is positive;
storage of the new version of the software application in a standby memory zone of the on-board equipment item, where the latter is controlled by a prior version of said software application stored in an active memory zone of the on-board equipment item separate from the standby memory zone;
switching of the standby memory zone and of the active memory zone of the on-board equipment item, the latter then being controlled, after switching, by the new version of the software application stored in the active memory zone.

After being stored in its standby memory zone, the equipment item advantageously makes a second check of the integrity of the new version of the software application, and the active and standby memory zones are switched only if this second check is positive.

Typically, the new version of the software application is transmitted to the on-board equipment item in the form of a succession of software files, each software file being stored in a standby memory zone, and its integrity then being checked.

After the step of storage in its standby memory zone, the equipment item may make a third check of the compatibility of the new software application version with the equipment item's existing hardware and/or software configuration, and the active and standby memory zones are then switched only if this third check is positive.

The switching of the equipment item's standby memory zone and active memory zone may in all cases be determined by said equipment item itself.

Alternatively, the switching of the equipment item's standby memory zone and active memory zone may be determined by the on-board dataloader.

The switching of the standby memory zone and of the active memory zone may be determined in accordance with the aircraft's flight phase.

The switching of the equipment item's standby memory zone and active memory zone may also be controlled by an order of the maintenance server, said order then being relayed to the on-board equipment item by the dataloader.

The dataloader advantageously transmits a request for configuration information to the on-board equipment item, and the latter transmits back a response containing at least one identifier of the version of the software application stored in the active memory zone.

Alternatively, the equipment item transmits to the dataloader at regular intervals a configuration message containing at least one identifier of the version of the software application stored in the active memory zone.

If an operational fault is detected after the standby memory zone and active memory zone have been switched, a switch is made in the reverse direction.

The update files are preferably downloaded between the maintenance server and the dataloader by means of a wireless link.

### BRIEF DESCRIPTION OF THE DRAWINGS

Other characteristics and advantages of the invention will appear on reading the embodiments of the invention described below in relation to the single figure.

The single FIGURE illustrates schematically a flow chart of the method for updating an on-board software application, according to one embodiment of the invention.

### DETAILED DESCRIPTION

The basic idea of the invention is to include in each equipment item a first memory zone, called the standby memory zone, and a second memory zone, called the active memory zone. When a new version of a software application is downloaded by the loading device in the equipment item in question, it is stored in the standby memory zone, and the previous version stored in the active memory zone continues to control the equipment item. When the new version is fully loaded in the standby memory zone and the integrity checks have been carried out, the respective roles of the standby memory zone and the active memory zone are reversed. In other words, the new version of the software application stored in the active memory zone then controls the equipment item, whereas the standby zone contains the previous version of the software application.

In what follows, an aircraft will be considered having multiple on-board equipment items, such as avionics computers, avionics information systems, and systems to provide passengers with information and entertainment. Each of these equipment items contains a software application able to be updated in the course of a maintenance operation. The equipment items are connected to a dataloader, via a network such as, for example, an AFDX network (Avionics Full-Duplex Switched Ethernet) in conformity with the Arinc 664 protocol, or alternatively a data bus network in conformity with the Arinc 429 protocol.

The dataloader may take a centralised or a distributed form. In the distributed form, the dataloader may include multiple elementary download devices, respectively dedicated to separate domains such as the ACD (Aircraft Control Domain), the AISD (Airline Information Service Domain) or the PIESD (Passenger Information and Entertainment Services Domain), as defined in standard Arinc 811. Alternatively, the dataloader may include a first download device dedicated to the aircraft's secure domain, and a second download device dedicated to the aircraft's open domain. For example, the ACD forms part of the aircraft's secure domain, whereas the AISD and PIESD form part of its open domain.

The dataloader may be resident on the aircraft. The maintenance server, located on the ground, then transmits the update files to the dataloader either by wired means, whether electrical or optical, (an Ethernet network, for example, where the connection with the network is established for example when the aircraft is parked at the departure gate), or by means of a wireless link, for example a Wi-Fi, WiMAX or similar link.

According to one variant, the dataloader consists of an on-board platform. In this case, during a maintenance operation, a portable download terminal may be connected to the platform by means of a wired link, for example an RJ45 cable or a USB cable. The update files are then transferred from the terminal to the platform via the wired link.

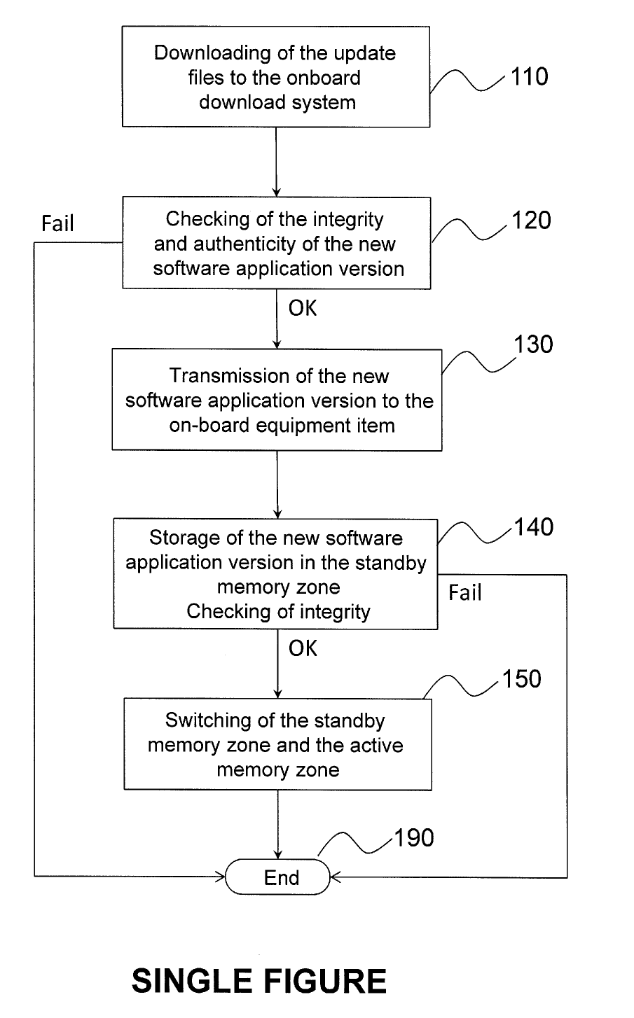

FIG. 1 illustrates schematically a flow chart of the method for updating an on-board software application, according to one embodiment of the invention.

In step 110 a new version of the software application intended for an equipment item of the aircraft is downloaded in the form of a series of update files, by a wired or wireless link, to the on-board dataloader.

The series of update files includes the actual software application files, and at least one support file containing, firstly, data enabling the authenticity and integrity of each and/or all of the software application files with which it is associated to be checked. This may consist in particular of digital certificates in X.509 format, timestamp tokens, digital signatures, etc. The support file advantageously contains indications notably enabling the on-board dataloader to determine the equipment item or items to which said software application files are to be transmitted. Said series of files may also include help files providing additional update information for the dataloader and/or for the equipment items concerned.

For example, when the series of update files is in conformity with the Arinc 665 standard, this series takes the form of Field Loadable Software, including a header file (with a .luh file extension) giving the destination and the authenticity/integrity data of each of the following files, one or more software application files themselves, called the Data Files, and one or more update help files, called the Support Files, providing update data for the dataloader and/or for the equipment items concerned.

In step 120, after the series of update files has been fully downloaded into the buffer of the dataloader, the latter checks the authenticity and integrity of the software application files and, if applicable, of the help files.

It is recalled that the term “authenticity” means that the files are indeed from a source known to the dataloader. The term “integrity” means that the files have not been modified deliberately or accidentally during transmission or storage.

If the check is negative the update procedure is aborted and terminates at 190.

Conversely, if the check is positive, the software application files, together with a proportion at least of the support file and help files, are transmitted at 130 by the on-board dataloader to the equipment items concerned by the update. To do so, the dataloader determines, on the basis of the information contained in the support file, the equipment items to which the software application file(s) must be transmitted. Various implementations of step 130 are conceivable, according to the type of network connecting the equipment items due to receive the files to the dataloader. Thus, in a known manner, a download mode according to the Arinc 615 standard for a network of the Arinc 429 type, a download mode according to the Arinc 615A standard for an AFDX network, and a download mode according to the Arinc 825/826 standard for a CAN bus may be implemented.

In step 140 each equipment item stores in its standby memory zone the software application file or files which are transmitted to it by the dataloader in step 130. According to a first variant, the equipment item checks the integrity of each software application file using the integrity data (for example CRC) in the support file. According to a second variant, the equipment item stores the software application files as they are received in its standby memory zone. When the final software application file has been received and stored, the equipment item then checks the integrity of all the software application files using the integrity information in the support file.

If the integrity check is negative the update method terminates at 190.

If certain cases the equipment item may make a series of tests the aim of which is to check the compatibility of the new software application with the hardware of the equipment item and/or the software which is/are already present, or otherwise with the existing hardware and/or software configuration.

Once again, if the compatibility diagnosis is negative the update method terminates at 190.

It is important to note that, during the steps of transmission, storage, and integrity and compatibility checking, the equipment item continues to operate using the software application version stored in the active memory zone.

In step 150 a switch is made between the active memory zone and the standby memory zone. This switch may be made autonomously by the equipment item, or alternatively in centralised fashion by the dataloader, as described below.

After the switch has been made the update terminates at step 190.

It should be noted that, if the equipment item diagnoses an operating error after the switch it could still switch back to the prior version of the software application by performing a switch in the reverse direction, i.e. by switching once again the active memory zone with the standby memory zone. Indeed, the prior version of the software application present in the standby memory zone will be deleted only when another download occurs.

The dataloader can learn at any time the version of the software application which is active within a given equipment item. To do so the dataloader transmits a configuration information request to the equipment item (for example an information request according to the Arinc 615 protocol). The equipment item responds with a configuration report specifying the version number of the software application stored in the active memory zone. Alternatively, the equipment item's configuration report may specify the version numbers of the software application stored respectively in the active memory zone and the standby memory zone. If the Arinc 615 protocol is adopted, the equipment item's configuration report may take the form of an individual frame which may be identified by a specific FIN (Function Indication Number) field, where this frame provides a PNR (Part NumbeR) identifier of the software application stored in the active memory zone (PNR_active) and a PNR identifier of the software application stored in the standby memory zone.

Alternatively, an equipment item may systematically transmit a message at regular intervals specifying its configuration. As above, the message may contain the identifier of the software version stored in the active memory zone of the equipment item and, if applicable, that of the version stored in the standby memory zone.

According to a first variant embodiment, the switch between the standby memory zone and the active memory zone is made autonomously by the on-board equipment item.

In this variant the equipment item firstly determines whether it is in a flight phase in which maintenance is authorised. This flight phase may be determined on the basis of data received from sensors and/or avionics systems. As a general rule, maintenance of an equipment item is possible only when the aircraft is stationary on the ground. In this case the equipment item must check beforehand whether the ground immobilisation conditions are indeed satisfied: landing gear compressed, engines shut down, parking brake on, etc. In other cases, maintenance of an equipment item may be undertaken during flight, if it is not prejudicial to aircraft safety.

After checking that it is indeed in a maintenance phase, the equipment item may switch its active memory and reserve memory zones. In certain cases it will also check, before switching, that the software application version stored in the reserve memory zone is more recent than the version stored in the active memory zone.

According to a second variant embodiment, the switch between the equipment's standby memory zone and active memory zone is made in centralised fashion by the dataloader.

The dataloader firstly determines whether it is in a flight phase authorising maintenance of the equipment items concerned. If this is indeed so, it transmits a request for an active memory zone/standby memory zone switch to these equipment items. These equipment items may transmit an acknowledgement message after performing the switch in question. Alternatively, as described above, the dataloader may interrogate the various equipment items, in order to know the active software application version, and therefore to check that the switch has indeed been made. As another alternative, if the equipment items transmit messages at regular intervals specifying their configurations, the dataloader may also check that the switch has indeed been made. Whatever the envisaged checking mode, if the switch has failed the dataloader may notify the aircraft's centralised maintenance system and/or the ground maintenance server of this fact. Conversely, if the dataloader detects that the switch has indeed been made by all the equipment items concerned by the maintenance operation, it may confirm this operation, and notify the ground maintenance server of this fact. In this case it may also delete the local copy of the series of files used for the update.

According to a third variant embodiment, switching of the memory zones is activated by the ground maintenance server. In this case, the switching order is simply relayed by the dataloader to the equipment items concerned by the maintenance operation. For example, an airline's maintenance server may activate a given maintenance operation for all aircraft of a given type in its fleet. This variant enables maintenance operations to be synchronised optimally.

Those skilled in the art will understand that various combinations of the variants described above are also conceivable, without however going beyond the scope of the invention. Thus, certain equipment items may accomplish the memory zones switch autonomously, whereas others will be subject to centralised control by the dataloader. The third variant embodiment may also coexist with the first and second variants in the sense that a switching order of the airline's maintenance server will have priority over the other switching modes.

1. A method for updating a software application stored in an equipment item on board an aircraft, comprising:
downloading of files to update the software application, from a maintenance server on the ground to an on-board dataloader, where the update files comprise a new version of the software application;
a first check of the integrity and authenticity of the new version of the software application by the on-board dataloader, where the method is characterised in that it also comprises:
transmission of the new version of the software application by the on-board dataloader to the on-board equipment item, when the check is positive;
storage of the new version of the software application in a standby memory zone of the on-board equipment item, where the latter is controlled by a prior version of the software application stored in an active memory zone of the on-board equipment item separate from the standby memory zone;
switching of the standby memory zone and of the active memory zone of the on-board equipment item, the latter then being controlled, after switching, by the new version of the software application stored in the active memory zone.

2. A method for updating a software application according to claim 1, characterised in that, after being stored in its standby memory zone, the equipment item makes a second check of the integrity of the new version of the software application, and the active and standby memory zones are switched only if this second check is positive.

3. A method for updating a software application according to claim 2, characterised in that the new version of the software application is transmitted to the on-board equipment item in the form of a succession of software files, each software file being stored in a standby memory zone, and its integrity then being checked.

4. A method for updating a software application according to claim 2, characterised in that, after the step of storage in its standby memory zone, the equipment item makes a third check of the compatibility of the new software application version with the equipment item's existing hardware and/or software configuration, and the active and standby memory zones are then switched only if this third check is positive.

5. A method for updating a software application according to claim 1, characterised in that the switching of the standby memory zone and the active memory zone of the equipment item is determined by the equipment item itself.

6. A method for updating a software application according to claim 1, characterised in that the switching of the standby memory zone and the active memory zone of the equipment item is determined by the on-board dataloader.

7. A method for updating a software application according to claim 5, characterised in that the switching of the standby memory zone and the active memory zone is determined in accordance with the aircraft's flight phase.

8. A method for updating a software application according to claim 1, characterised in that the switching of the standby memory zone and the active memory zone of the equipment item is controlled by an order of the maintenance server, where the order is relayed to the on-board equipment item by the dataloader.

9. A method for updating a software application according to claim 1, characterised in that the dataloader transmits a configuration information request to the on-board equipment item, and in that the latter returns a response containing at least one identifier of the software application version stored in the active memory zone.

10. A method for updating a software application according to claim 1, characterised in that the equipment item transmits to the dataloader at regular intervals a configuration message containing at least one identifier of the software application version stored in the active memory zone.

11. A method for updating a software application according to claim 1, characterised in that, if an operating fault is detected after the standby memory zone and the active memory zone have been switched, a switch in the reverse direction is made.

12. A method for updating a software application according to claim 1, characterised in that the download of the update files between the maintenance server and the dataloader is accomplished by means of a wireless link.
